(19) United States
(12) Patent Application Publication
(10) Pub. No.: US 2022/0324412 A1
(43) Pub. Date: Oct. 13, 2022

(54) VEHICLE OCCUPANT RESTRAINT SYSTEM FOR A MOTOR VEHICLE, AND METHOD FOR RESTRAINING A VEHICLE OCCUPANT

(71) Applicant: ZF AUTOMOTIVE GERMANY GMBH, Alfdorf (DE)

(72) Inventors: Tillmann HERWIG, Stuttgart (DE); Roberto MARTIN, Lorch (DE); Christian BRANDENBURG, Gross-Umstadt (DE)

(21) Appl. No.: 17/633,971

(22) PCT Filed: Aug. 6, 2020
(86) PCT No.: PCT/EP2020/072096

§ 371 Date: Feb. 9, 2022

(30) Foreign Application Priority Data
Aug. 13, 2019 (DE) 10 2019 121 734.2

(51) Int. Cl. B60R 22/26; B60N 2/02; B60N 2/427

(52) U.S. Cl. CPC B60R 22/26; B60N 2/0276; B60N 2/42745

(57) ABSTRACT

A vehicle occupant restraint system for a motor vehicle comprises a vehicle seat (14) including a seat (16) and a backrest (18), and comprises an actor (12) that is arranged to set the seat (16) relative to the backrest (18) so as to actively reduce an angle (α) between the seat (16) and the backrest (18) during crash or before crash. In addition, the invention describes a method for restraining a vehicle occupant.

### TECHNICAL FIELD

The invention relates to a vehicle occupant restraint system for a motor vehicle and to a method for restraining a vehicle occupant.

### BACKGROUND

In vehicles driving autonomously or partly autonomously comfortable vehicle seating positions are very important as possibly there is no human vehicle operator any more.

For this purpose, the backrest could be strongly reclined toward the horizontal to reach a so-called fully reclined position. In general, a similar vehicle seat position is conceivable for the front passenger already in conventional vehicles, as the front passenger does not have to steer the vehicle.

In said position, the effect of the restraint systems known from prior art for vehicle seats is typically reduced, however. This would have an impact in particular if a crash occurs in such a seat position, i.e., while one of the vehicle occupants is in the fully reclined position.

### SUMMARY

Therefore, it is the object of the invention to provide a vehicle occupant restraint system that enables an improved effect of the restraint systems, in particular also in nontypical seat positions such as a reclined position.

The object is achieved by a vehicle occupant restraint system for a motor vehicle, comprising a vehicle seat that includes a seat and a backrest, and an actuator arranged to set the seat relative to the backrest so as to actively reduce an angle between the seat and the backrest during crash or prior to crash.

The invention is based on the basic idea of the angle between the backrest and the seat being varied actively from a position inclined toward the horizontal to an upright position of the backrest. To this end, an actor is provided for setting the seat relative to the backrest while at the same time reducing the angle between the seat and the backrest. This results in a more upright position of the vehicle seat. Hence, the more upright position of the vehicle seat helps improve the effect of the restraint system of the vehicle seat.

In accordance with the invention, setting the seat relative to the backrest is understood to be the fact that the position of the seat changes compared to the upper edge of the backrest. The upper edge of the backrest is understood to be the intersection of a horizontal tangent and a vertical tangent with the upper end of the backrest, i.e., with the end of the backrest that is not adjacent to the seat.

Consequently, the backrest is not actively moved to set the vehicle seat to the more upright position, as this would cause an additional acceleration to act upon the torso of the vehicle occupant in the direction of the steering wheel and, resp., the instrument panel. In the event of a frontal crash, said acceleration would negatively affect the restraint of the occupant. The more upright position of the vehicle seat is ensured by a movement of the seat relative to the backrest.

In other words, an active movement is carried out substantially in the horizontal in which the seat is movable.

The vehicle occupant restraint system may be arranged to substantially maintain the horizontal position of the upper edge of the backrest after the angle is reduced. In other words, the backrest is substantially not set with respect to its upper edge.

The term to substantially maintain means especially that the upper edge of the backrest changes by less than 5 cm in the horizontal direction. The horizontal direction substantially corresponds to the longitudinal direction of the vehicle in this context.

The movement of the upper edge of the backrest thus takes place primarily in the vertical direction, thus causing an additional pulse due to a frontal or oblique impact acting on the vehicle occupant in the horizontal direction to be suppressed. In a frontal or oblique impact of the vehicle, thus no additional pulse is transmitted to the vehicle occupant in the direction of the steering wheel and/or the instrument panel by setting up the backrest due to the movement of the seat relative to the backrest.

In the event of a rear impact or when occupants are directed to the rear relative to the driving direction, a set-up backrest may constitute an optimized reaction surface that improves restraint of the occupant.

In order to ensure proper seatbelt connection with the vehicle occupant, the vehicle seat may comprise a seat-integrated seatbelt.

Also, further seatbelt components such as a belt tensioner and/or a webbing extension protection may be provided. Said seatbelt components may also be provided at the vehicle seat, for example integrated in the seat.

The actor can be in the form of a hydraulic actor, an electric actor and/or a pyrotechnic actor. Said configurations of the actor represent options to apply the force required for setting the angle between the backrest and the seat. The appropriately configured actor acts upon the seat to set the latter in the horizontal.

The actor may be provided to have a mechanical function, in particular to comprise a biased spring. The mechanical function enables the angle between the backrest and the seat to be quickly set in the event of crash, in particular also when an imminent crash is detected.

In the case of a rear impact and/or when occupants are positioned opposite to the driving direction in the event of a frontal or oblique impact, the deceleration occurring (negative acceleration) can be used for the horizontal displacement of the seat.

There may be provided another actor that acts on the backrest and/or on a joint of the vehicle seat provided between the backrest and the seat. This results in reduced complexity of the vehicle occupant restraint system, as one actor moves the seat in the horizontal direction and the other actor reduces the angle between the seat and the backrest. The further actor can ensure that, when the seat moves in the horizontal direction, the backrest will not move in the horizontal direction.

In one configuration of the invention, the further actor is arranged to substantially maintain the upper edge of the backrest in the horizontal direction, when the actor sets the seat relative to the backrest. Hence, the further actor counteracts a possible horizontal movement of the backrest that might be induced by the horizontal movement of the seat.

The two actors thus can interact and can be connected to each other so that the seat is set synchronously to the reduction of the angle between the backrest and the seat. This results in an as quick reduction of the angle as possible between the seat and the backrest. In other words, the control of the two actors may be adapted to each other, for example by means of a higher-level control of the vehicle occupant restraint system.

The object of the invention is further achieved by a method for restraining a vehicle occupant being seated in a vehicle seat of a motor vehicle that comprises a seat and a backrest, by means of the following steps of:
detecting a crash and/or an imminent crash, and
displacing the seat relative to the backrest by an actor to actively reduce an angle between the seat and the backrest during crash or prior to the crash.

By reducing the angle between the seat and the backrest, the position of the occupant with respect to an imminent restraint due to a frontal, oblique but also rear impact is improved. This is possible as the position of the vehicle seat is transferred to a more upright position by virtue of the reduction of the angle.

In addition, the effect of the belt system is improved due to better positioning relative to the occupant with respect to the restraining characteristics thereof.

In the event of a rear impact, setting up the backrest results in an optimized position of the reaction surface which prevents the occupant from sliding down along the backrest, and thus improves restraint of the occupant.

The method may be configured so that the upper edge of the backrest is held substantially at a horizontal position. The upper edge of the backrest is thus moved mainly in the vertical position and only small load is applied to the vehicle occupant in the horizontal direction.

The above-described vehicle occupant restraint system is especially provided to be capable of carrying out the described method and, resp., the method is provided to be carried out by the above-described vehicle occupant restraint system.

### BRIEF DESCRIPTION OF THE DRAWINGS

Further features and advantages of the invention will be evident from the following description and from the attached drawings which are referred to and wherein:

FIG. 1 shows a schematic lateral view of a vehicle occupant restraint system according to the invention in a first embodiment, and

FIG. 2 shows a schematic lateral view of a vehicle occupant restraint system according to the invention in a second embodiment.

### DESCRIPTION

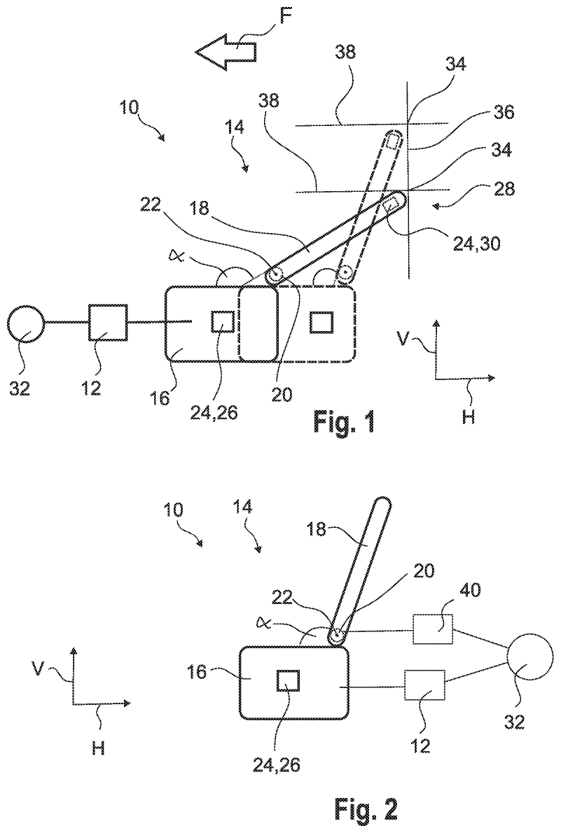

FIG. 1 shows a schematic lateral view of a vehicle occupant restraint system 10 comprising an actor 12 and a vehicle seat 14.

The vehicle seat 14 is shown in two different positions. The vehicle seat 14 shown by a continuous line corresponds to the position of the vehicle seat 14 in a home position, and the vehicle seat 14 shown by broken lines corresponds to a position shortly before or during a crash. For reasons of clarity, the reference symbols relating to the vehicle seat 14 are inserted only once.

The vehicle seat 14 includes a seat 16 and a backrest 18. The backrest 18 is articulated in the lower region by a joint 20 to the rear region of the seat 16 and is pivoted about a pivot axis 22 that is located inside the joint 20.

Hence, the backrest 18 may be equipped with a mechanism known from the state of the art, such as an electric motor so that the backrest 18 can be pivoted about the pivot axis 22.

The backrest 18 has an angle α with the seat 16. In the home position of FIG. 1, the angle α is about 150°, which corresponds to a fully reclined position as it could be adopted in an autonomously driving vehicle, for example.

The vehicle seat 14 further includes seatbelt components 24. For example, a fastening device 26 is provided at the seat 16 of the vehicle seat 14 to fasten the plug-in tongue of a seat belt (not shown) in the fastening device 26. Consequently, the fastening device 26 is a belt buckle, for example.

Moreover, at the upper end 28 of the backrest 18 a webbing retractor 30 is provided to retract the webbing of the seatbelt. The seatbelt of the vehicle seat 14 (not shown) therefore is a seat-integrated seatbelt. There may also be provided further seatbelt components 24 such as a belt tensioner.

The actor 12 is connected to the seat of the vehicle seat 14 and can set the seat 16 relative to the backrest 18. The representation of the actor 12 in the front region of the seat 16 and, thus, on the side opposite to the backrest 18 is meant to be exemplary only.

The actor 12 is connected to a control system 32 that is adapted, inter alia, to control the actor 12 and thus to initiate the movement of the seat 16. The control system 32 may be a control system of the vehicle occupant restraint system 10 or the central control system of the vehicle.

The actor 12 may be a hydraulic actor comprising a hydraulic cylinder, for example, that acts upon the seat 16.

It is also imaginable that the actor 12 is an electric actor such as an electric motor which displaces the seat 16 along a rail of the vehicle seat 14.

Alternatively, or additionally, the actor 12 may be a pyrotechnic actor, i.e., an actor containing a chemical, in particular pyrotechnic, composition that reacts to generate a pressure wave so as to move the seat 16. The actor 12 therefore may comprise a gas generator or the like.

In one configuration of the invention, the actor 12 comprises a biased spring so that the spring jerkily expands, e.g., by releasing a clip and, in so doing, moves the seat 16.

It is also imaginable that in the case of rearwardly directed occupants due to a frontal or oblique impact or of forwardly directed occupants due to a rear impact the actor 12 can be replaced or assisted by exploiting the crash deceleration or is based on any other mechanical function.

Basically, the actor 12 is configured to set the seat 16 in the horizontal, that is in the horizontal direction or in the longitudinal direction of the vehicle.

The actor 12 is configured to actively set the seat 16 before or during crash relative to the backrest 18 so as to reduce the angle α between the seat 16 and the backrest 18, thus bringing the vehicle seat 14 to a more upright position. Said setting of the seat shall be explained as follows.

Reference is made to the coordinate system shown in FIG. 1 by the arrows V, H arranged at right angles.

The arrow H points to the horizontal direction and the arrow V points to the vertical direction perpendicular thereto. The coordinate system has to be understood with respect to the mounting position of the vehicle seat 14 in a vehicle. The horizontal direction thus corresponds to the plane in which the vehicle moves, and the vertical direction must be understood to be perpendicular thereto.

The control system 32 detects an (imminent) frontal crash, for example, shown by the large arrow F which represents the inertia force of the vehicle occupant or the force acting from outside, if the vehicle seat 14 is rotated by 180° in the plane, which may be the case in an autonomously driving vehicle.

After the control system 32 has detected the (imminent) crash, the control system 32 controls the actor 12 so that the latter moves the seat 16 relative to the backrest 18. The actor 12 is configured such that the horizontal position of the upper edge 34 of the backrest 18 remains substantially unchanged. The horizontal position of the upper edge 34 of the backrest 18 moves by less than 5 cm in the horizontal direction, for example, as merely the seat 16 is actively set in the horizontal direction.

It is evident from FIG. 1 that the upper e vertical direction and a tangent 38 extending in the horizontal direction to the upper end 28 of the backrest 18.

By comparing the positions of the upper edge 34 between the home position (shown by the continuous line) and the position before or during the accident (shown by the broken line) it is visible that the upper edge 34 has moved substantially only in the vertical direction.

The angle α between the backrest 18 and the seat 16 is reduced by the movement of the seat 16 along the horizontal and the upper edge 34 in the vertical direction. In the position before or during crash, the angle α is about 110° instead of 150° before. The vehicle seat 14 thus has been set to a more upright position by having actively moved merely the seat 16.

The setting of the seat 16 prevents an additional pulse being exerted on the occupant of the vehicle seat 14 in the direction of the crash, which would be the case if the backrest 18 was actively set to an upright position.

Positioning of the actor 12 in FIG. 1 is only meant to be schematic, as the actor 12 can be arranged at different positions.

In general, it is also imaginable that an inclination sensor which is capable of measuring the angle α between the backrest 18 and the seat 16 is present in the joint 20. The inclination sensor can allow the control system 32 to fix a value, for example, by which the angle α must be changed and can appropriately control the actor 12.

By way of FIG. 2, hereinafter a second embodiment of the vehicle occupant restraint system 10 is illustrated that corresponds substantially to the embodiment shown in FIG. 1 so that only the differences shall be discussed in the following. Equal and equally functioning components are provided with the same reference symbols.

FIG. 2 shows the vehicle occupant restraint system 10 in a schematic lateral view.

In contrast to the first embodiment, the vehicle occupant restraint system 10 of FIG. 2 does not include a seat-integrated seatbelt. The belt retractor 30 is fastened to the B pillar of the vehicle, for example, and therefore is not shown in FIG. 2.

Moreover, in addition to the actor 12, another actor 40 is provided that acts upon the joint 20 of the backrest 18. Both the actor 12 and the actor 40 are connected to the control system 32 that controls the actors 12, 40.

In this embodiment, the actor 12 moves the seat in the horizontal direction and the actor 40 pivots the backrest 18 about the pivot axis 22 so that the angle α is reduced.

The actor 40 is configured so that the horizontal position of the upper edge 34 of the backrest 18 does not change when setting the seat 16. In other words, the actor 40 counteracts an induced movement of the backrest 18 in the horizontal direction.

For this purpose, further sensors may be provided at the backrest 18 and, resp., generally at the vehicle seat 14.

As a matter of course, the different features of the two embodiments can be combined with each other at will. In particular, the features listed as differences concerning the second embodiment are independent and may also be provided in a different manner in the first embodiment.

1-10. (canceled)

11. A vehicle occupant restraint system for a motor vehicle, comprising a vehicle seat (14) including a seat (16) and a backrest (18), and comprising an actor (12) that is arranged to set the seat (16) relative to the backrest (18) so as to actively reduce an angle (α) between the seat (16) and the backrest (18) during a crash or before a crash.

12. The vehicle occupant restraint system according to claim 11, wherein the vehicle occupant restraint system (10) is arranged to substantially maintain the horizontal position of the upper edge (34) of the backrest (18) after reducing the angle (α), in particular wherein the horizontal position changes by less than 5 cm.

13. The vehicle occupant restraint system according to claim 11, wherein the vehicle seat (14) comprises a seat-integrated seatbelt.

14. The vehicle occupant restraint system according to claim 11, wherein the actor (12) is a hydraulic actor, an electric actor and/or a pyrotechnic actor.

15. The vehicle occupant restraint system according to claim 11, wherein the actor (12) has a mechanical operating mode, in particular a biased spring.

16. The vehicle occupant restraint system according to claim 11, wherein another actor (40) is provided that acts upon the backrest (18) and/or upon a joint (20) of the vehicle seat (14) which is provided between the backrest (18) and the seat (16).

17. The vehicle occupant restraint system according to claim 16, wherein the further actor (40) is arranged to substantially maintain the upper edge (34) of the backrest in the horizontal direction when the actor (12) sets the seat (16) relative to the backrest (18).

18. A method for restraining a vehicle occupant being seated in a vehicle seat (14) of a vehicle that comprises a seat (16) and a backrest (18), by means of the following steps of:
a) detecting a crash and/or an imminent crash, and
6. displacing the seat (16) relative to the backrest (18) by an actor (12) to actively reduce an angle (α) between the seat (16) and the backrest (18) during crash or before crash.

19. A method for restraining a vehicle occupant being seated in a vehicle seat (14) of a vehicle that comprises a seat (16) and a backrest (18), by means of the following steps of:
a) detecting a crash and/or an imminent crash, and
b) displacing the seat (16) relative to the backrest (18) due to the deceleration caused by the crash to passively reduce an angle (α) between the seat (16) and the backrest (18) during crash.

20. The method according to claim 18, wherein an upper edge (34) of the backrest (18) is substantially held at a horizontal position.
